(19) United States
(12) Patent Application Publication
(10) Pub. No.: US 2017/0030425 A1
(43) Pub. Date: Feb. 2, 2017

(54) FRICTION LINING FOR INDUSTRIAL BRAKES AND DRIVE ELEMENTS AND METHOD FOR PRODUCING A FRICTION LINING FOR INDUSTRIAL BRAKES AND DRIVE ELEMENTS

(71) Applicant: Schaeffler Technologies AG & Co. KG, Herzogenaurach (DE)

(72) Inventors: Vera Ruhrup, Morsbach Ellingen (DE); Frank Steinhauer, Forst (DE); Thorsten Weyel, Willmenrod (DE); Christian Spandern, Elkenroth (DE); Daniel Meissner, Eitorf (DE); Stefan Lohr, Mudenbach (DE)

(73) Assignee: Schaeffler Technologies AG & Co. KG, Herzogenaurach (DE)

(21) Appl. No.: 15/303,356

(22) PCT Filed: Apr. 23, 2015
(86) PCT No.: PCT/DE2015/200274

§ 371 Date: Oct. 11, 2016

(30) Foreign Application Priority Data
Apr. 28, 2014 (DE) 10 2014 207 968.3
Jul. 16, 2014 (DE) 10 2014 213 779.9

(51) Int. Cl. F16D 69/02; B29C 65/48; B29C 65/02

(52) U.S. Cl. CPC F16D 69/025; B29C 65/02; B29C 65/48; B29L 2031/16

(57) ABSTRACT

The invention relates to a friction lining for industrial brakes and drive elements, said lining including a dual-layer structure, a friction layer being connected to a backing layer. In such a friction lining which is particularly suited to industrial applications, the backing layer is inherently resilient and the friction layer and/or the backing layer is/are produced from a synthetic material-elastomer composite.

### BACKGROUND

The invention relates to a friction lining for industrial brakes and drive elements with a dual-layer structure, with a friction layer being connected to a backing layer, as well as a method for the production of a dual-layer friction lining.

Friction linings in industrial brakes and industrial drive elements, such as clutches, serve to hold a static load (holding brake), brake a rotary motion (dynamic brake), or compensate relative motions (clutches). A dual-layer friction material is known from DE 697 26 641 T2, which comprises a fibrous basic material. This fibrous basic material has a first layer and a second layer, which are connected to each other during a wet paper production method. Here, a first layer is made from friction material, which comprises fibers and/or fillers and/or friction particles. A second layer made from friction material also comprises fibers and/or fillers and/or friction particles and is formed on top of the first layer. Such friction material is particularly suited for the application in modern transmission systems and brake systems in the automotive industry, where it is preferably used in wet clutch systems.

Contrary to automotive applications, in industrial equipment the friction linings are fixed directly on a stiff rotor. It is typically made from metal or fiber reinforced plastic. Here it is disadvantageous that the friction lining is not in all applications in an optimal contact with the counterpart.

High friction values and high wear resistance can in such applications be realized only with very hard materials. This results in locally overheating friction linings and reduction in friction values connected thereto, increased wear and tear, and perhaps the development of noise and odors.

From DE 10 2011 000 720 A1 a friction brake is known for elevators exhibiting improved damping features, in which a friction lining embodied in a fork-like fashion engages a rail during a braking process. The brake lining is here embodied as a single layer. Laterally next to the friction linings, here damping elements are arranged, largely preventing any rubbing of the friction linings in the released state of the brake at the rail.

### SUMMARY

The invention is therefore based on the objective to provide a friction lining for industrial brakes and industrial drive elements, which exhibits good friction features and largely prevents any reduction in friction values and/or increased wear and tear of the industrial brake.

According to the invention, this objective is attained in that the backing layer is embodied inherently resilient and the friction layer and/or the backing layer are made from a synthetic elastomer composite. By this two-layer embodiment here a functional separation of the friction lining develops, with the backing layer implementing the inherent resilience towards the stiff rotor and the friction layer realizing the good friction features. In both cases the use of a synthetic-elastomer composite allows that the friction layer, in addition to the high friction value, also shows low rates of wear and tear, while the backing layer provides resilience as good as possible. By the inherently resilient embodiment of the backing layer, here additional damping elements can be waived.

Advantageously the backing layer includes 10% to 40% elastomer, 0% to 20% resins, and 40% to 80% fillers materials and/or additives, while the friction layer comprises 0% to 25% elastomer, 5% to 30% resins, and 45% to 70% fillers and additives. This composition of the respective synthetic elastomer composite for the backing layer and/or friction layer fulfills the demands set for the use of friction linings for industrial brakes and drive elements, such as industrial clutches.

In one embodiment the elastomer of the backing layer represents rubber. Such rubber, preferably SBR-rubber (styrene-butacliene rubber) acts in a particularly good resilient fashion.

In one variant the backing layer shows in the finished state of the friction lining a shore hardness of maximally 100 ShD. With this maximum hardness it is ensured that the backing layer exhibits sufficient inherent resilience. The ideal hardness depends on the application, the compression, and the friction lining used.

In another embodiment the backing layer exhibits in the finished state of the friction lining a shearing strength of at least 1 N/mm². By this shearing strength, high resistance of the backing layer is ensured against shearing off under the forces developing during the braking process.

In one embodiment the friction layer includes grooves. Such grooves decouple the individual segments of the friction layer and can respectively align in an ideal fashion, which leads to better transmission of momentum by the friction layer.

Advantageously the friction layer is partially or entirely separated by these grooves. The greater the separation of the friction layer by the grooves, the better the decoupling of the segments of the friction layer.

A further development of the invention relates to a method for the production of a dual-layer friction lining for industrial brakes and drive elements, in which a friction layer is connected to a backing layer. In one method the friction layer or the backing layer to be embodied in an inherently resilient fashion is produced in a pre-pressing method as a semi-finished part, onto which a base material of the backing layer, similar to granulate, or the friction layer is applied, which is then hot compressed to the semi-finished part. When using this method, a stable friction lining can be produced for industrial brakes and drive elements.

Advantageously the friction layer or the backing layer are compressed hot or cold or rolled or punched out for the production of the semi-finished part. This procedure can be selected based on the respective application.

In one alternative both the backing layer as well as the friction layer are produced as semi-finished parts and then connected to each other in a hot pressing method.

Another further development of the invention relates to a method for the production of a dual-layer friction lining for industrial brakes and drive elements, in which a friction layer is connected to a backing layer. In such a method the friction layer and the backing layer, to be embodied inherently resilient, are produced separately from each other as semi-finished parts, with the cured semi-finished parts then being glued to each other.

### BRIEF DESCRIPTION OF THE DRAWINGS

The invention allows numerous embodiments. Some of them shall be explained in greater detail based on the figures shown in the drawings.

Shown are:

FIG. 1 an exemplary embodiment of a friction lining according to the invention, and

FIG. 2 a top view of the friction layer of the friction lining according to the invention.

### DETAILED DESCRIPTION OF THE PREFERRED EMBODIMENTS

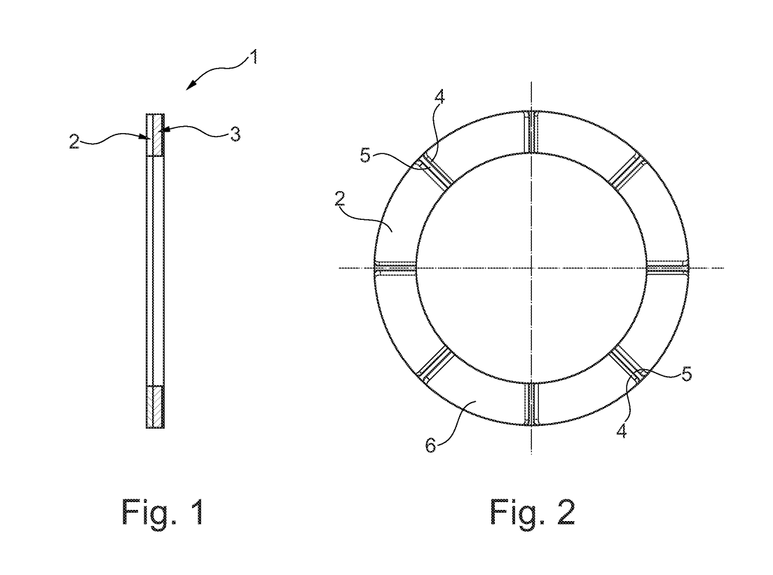

FIG. 1 shows an exemplary embodiment of a friction lining 1 according to the invention, which is embodied annularly. It is discernible from the side view that the friction lining 1 is made from two layers, i.e. a friction layer 2 and a backing layer 3, which is also called under-layer. The dual-layer friction lining 1 is fastened for the application via the backing layer 3 on a stiff rotor of the industrial brake or a drive element, for example a clutch. The friction layer 2 is a synthetic elastomer composite, which comprises 0% to 25% elastomer in the form of rubber and 5% to 30% resins. It has filler ratios from 45% to 70%.

The synthetic elastomer composite the backing layer 3 is made from is a composite material made from SBR-rubber, with the ratio thereof amounting from 10% to 40%. Additionally, from 0% to 20% resins and 40% to 80% fillers are contained therein. The backing layer 3 has in the finished state a hardness of maximally 80 ShD, preferably less than 60 ShD, in order to ensure sufficient inherent resilience of the backing layer. The ideal hardness depends on the respective application, the compression, and the friction layer used. The backing layer 3 has a shearing strength adjusted to the shearing and rotation forces developing in the respective application, however exceeding 1 N/mm², preferably exceeding 2 N/mm². Both layers 2, 3 are adjusted to each other such that they can be securely connected to each other.

As discernible from FIG. 2, the friction layer 2 comprises grooves 4 in equal distances on its surface, which almost completely penetrate the friction layer 2 in its depth. Here, the groove base 5 is embodied narrower than the opening of the groove 4 at the top of the friction layer 2. This way the segments 6 of the friction layer 2, marked similar to the parts of the friction layer 2 between the grooves 4, are decoupled and can therefore align in an ideal fashion.

The friction lining 1 described can be produced as follows. In a first embodiment the carrier layer 3 is hot pressed or cold pressed. Alternatively the backing layer 3 may be rolled or punched out. Subsequently, perhaps after a cutting process, the backing layer 3 produced as a semi-finished product is compressed with a prefabricated mixture for the friction layer 2 in a hot press. The prefabricated mixture for the friction layer 2 comprises here a base material similar to granulate.

In one alternative a base material similar to granulate can first be hot pressed or cold pressed or rolled or punched to form the friction layer 2 and this way it can be produced as a semi-finished product. After a potential cutting process a prefabricated mixture of the backing layer 3 similar to granulate is compressed in the hot press with the semi-finished part of the friction layer 2. Here the friction layer 2 and the backing layer 3 can be deformed, conically stressed, or loosely cured.

In another alternative the friction layer 2 and the backing layer 3 can be produced separately from each other as semi-finished parts and directly hot compressed with each other. The semi-finished parts can also be cured and subsequently glued to each other.

Due to this production process it is ensured that the dual-layer friction linings 1 can be produced with a predefined thickness ratio between the friction layer 2 and the backing layer 3. Furthermore, such a secure bonding between the two layers 2, 3 is ensured by way of assembly or directly compressing the materials. The friction linings 1 developed in this fashion have sufficiently small plating in order to allow easily integrating them into existing production processes of industrial brakes.

The solution presented provides friction linings with a dual-layer design and grooved friction layer for high dynamic and static friction values and good inherently resilient features as well as a reduced noise development for the use in industrial brakes and drive elements.

### LIST OF REFERENCE CHARACTERS

1 Friction lining
2 Friction layer
3 Backing layer
4 Groove
5 Groove base
6 Segment

1. A friction lining for industrial brakes and drive elements comprising a dual-layer structure, including a friction layer connected to a backing layer, the backing layer is embodied inherently resilient and at least one of the friction layer or the backing layer comprising a synthetic-elastomer composite.

2. The friction lining according to claim 1, wherein the backing layer comprises 10% to 40% elastomer, 0% to 20% resins, and 40% to 80% fillers, and the friction layer (2) comprises 0% to 25% elastomer, 5% to 30% resins, and 45% to 70% fillers.

3. The friction lining according to claim 2, wherein the elastomer of the backing layer is a rubber.

4. The friction lining according to claim 1, wherein the backing layer in a finished state of the friction lining has a shore hardness of maximally 100 ShD.

5. The friction lining according to claim 1, wherein the backing layer in the finished state of the friction lining has a shear strength of at least 1 N/mm².

6. The friction lining according to claim 1, wherein the friction layer includes grooves.

7. The friction lining according to claim 6, wherein the friction layer is at least partially separated by grooves.

8. A method for production of a dual-layer friction lining for industrial brakes and drive elements, in which a friction layer is connected to a backing layer, the method comprising: producing the friction layer or the backing layer as inherently resilient in a pre-pressing process as a semi-finished part, applying a base material of the backing layer or the friction layer and hot-compressing the base material with the semi-finished part.

9. The method according to claim 8, wherein for the production of the semi-finished part, the friction layer or the backing layer is hot or cold pressed or rolled or punched out.

10. A method for the production of a dual-layer friction lining for industrial brakes and drive elements, in which a friction layer is connected to a backing layer, the method comprising separately producing the friction layer and the backing layer embodied in an inherently resilient fashion from each other, and then hot compressing or gluing the friction layer and the backing layer together.
